(19) United States
(12) Patent Application Publication
(10) Pub. No.: US 2016/0032571 A1
(43) Pub. Date: Feb. 4, 2016

(54) Piezoelectric Touch-Controlled Faucet

(71) Applicant: ARTIKA FOR LIVING INC., Dorval (CA)

(72) Inventors: Raymond JEPSON, ROXBORO (CA); Oliver BRADLEY, Montreal (CA); Dave MORNEAU, Mont-Saint-Hilaire (CA)

(21) Appl. No.: 14/815,305

(22) Filed: Jul. 31, 2015

(30) Foreign Application Priority Data
Aug. 4, 2014 (CN) 201410380492.1

(51) Int. Cl. E03C 1/05; G05D 23/19; F16K 31/00; F16K 31/60; E03C 1/04; F16K 31/06

(52) U.S. Cl. CPC E03C 1/055; E03C 1/04; F16K 31/0644; F16K 31/004; F16K 31/60; G05D 23/19; E03C 2001/026

(57) ABSTRACT

The present invention relates to a piezoelectric touch-controlled faucet, falling under the technical field of automatic faucets. The faucet comprises a first end connected to a water supply source, a second end having a water outlet for the faucet, and a passage arranged between the first end and the second end for directing the water from the first end to the second end. The faucet further comprises an electronic valve arranged on the passage, and a touch area arranged on the external surface of the passage covering a certain area, wherein a piezoelectric sensor is arranged underneath the touch area, and an electronic control unit is connected to the piezoelectric sensor to receive signal from the piezoelectric sensor for controlling the electronic valve on and off. The electronic control unit may include an automatic time delaying unit. The piezoelectric touch-controlled faucet according to the present invention provides an improved touch control arrangement, reduces energy consumption, defines a touch area accurately, allows multi-touch control, and reduces the probability of accidental activation.

### TECHNICAL FIELD

The present invention relates to a piezoelectric touch-controlled faucet, falling under the technical field of automatic faucets.

### BACKGROUND ART

Automatic faucets are getting more and more applications in everyday life because of the various advantages thereof. For example, when someone washes his/her hands, the traditional faucets may be kept open until he/she finishes washing, and few people will turn off the faucets deliberately when they are using hand sanitizer during the process of washing hands. Furthermore, water may be wasted since the faucets do not be turned off tight after washing.

Some kinds of faucets in prior art may be spring type, and when in use, people need to press the switch with one hand and wash the other, and then swap over, so only one hand can be washed each time. People will not tend to do so because of public health problems, especially in public places. In a modified embodiment, after pressing the switch, the spring will return after a while, in this way, people can wash their hands at one time. But the spring type has a disadvantage-it is fragile and not reliable enough.

In order to solve the problem above, there also exists a non-contact automatic faucet in the prior art, which is provided with a proximity sensor and a power supply. When the proximity sensor detects something is approaching, it will transmit a signal to the power supply, and the power supply will drive the faucet to turn on, in this way, people will not worry about the public health problems anymore. Meanwhile, after washing hands, the proximity sensor detects nothing and transmits a signal to the power supply to turn off the faucet. It is benefit to saving water.

Although the non-contact automatic faucets have many advantages, but sometimes, people tend to control water supply by themselves. For example, especially at home, if people want to hold some water in a pot to wash something such as vegetables, the non-contact automatic faucets will be inconvenient to some extent, since people need to put their hands in the detection area of the proximity sensor to keep water supply in this circumstance.

In addition to the problems above, some other problems also need to be considered such as the position of the switch. If the position of the switch is convenient to people to use, people will tend to use, which is helpful to save water. Another problem needed to be considered is battery life. In view of safety and cost, many people tend to power the non-contact automatic faucet using battery.

Thus, energy consumption is another factor needed to be considered.

### SUMMARY OF THE INVENTION

Directed to above-mentioned various problems, an object of the present invention is to provide a piezoelectric touch-controlled faucet, which improves the control of a touch switch through reducing energy consumption, defines a touch area accurately, allows multi-touch control, and reduces the probability of accidental starting.

To achieve the above-mentioned object, the technical solution in the invention is:

a piezoelectric touch-controlled faucet, comprising:

a first end, which is connected to a water supply source,

a second end, comprising a water outlet of the faucet,

a passage, between the first end and the second end, which is used to lead the water at the first end to the second end,

characterised in that:

the piezoelectric touch-controlled faucet also includes an electronic valve, arranged in the passage,

and a touch area which covers an area is arranged on the external surface of the passage, wherein a piezoelectric sensor is arranged underneath the touch area, and an electronic control unit is connected to the piezoelectric sensor and receives signal from the piezoelectric sensor to control the electronic valve on and off,

the electronic control unit includes an automatic time delaying unit.

Preferably, the electronic valve is a solenoid valve.

Preferably, the touch area is arranged near the second end.

Preferably, the first end is connected to a hot water supply source and a cold water supply source at the same time.

Further, the piezoelectric touch-controlled faucet also includes a temperature control touch area.

Further, a LED temperature indicator is arranged near the temperature control touch area.

Preferably, the temperature control touch area is arranged near the first end.

Preferably, the second end is detachably connected to the passage, wherein a hosepipe is arranged in the passage, and the second end is connected with the hosepipe.

Further, the piezoelectric touch-controlled faucet also includes a manual valve, wherein the manual valve is arranged in the passage, and a handle, wherein the handle is used to control the manual valve on and off and to regulate water temperature.

The advantageous effects of the present invention are that the piezoelectric touch-controlled faucet improves the control of a touch switch through reducing energy consumption, defines a touch area accurately, allows multi-touch control, and reduces the probability of accidental starting.

### BRIEF DESCRIPTION OF THE DRAWINGS

The invention will now be explained in more detail with reference to figures illustrated in the drawings, wherein:

FIG. 1 shows a schematic diagram of the structure of the present invention;

FIG. 2 shows a front view of a preferred embodiment of the present invention;

FIG. 3 shows a side section view of the embodiment in FIG. 2 along the section line X-X.

### DETAILED DESCRIPTION OF EXEMPLARY EMBODIMENTS

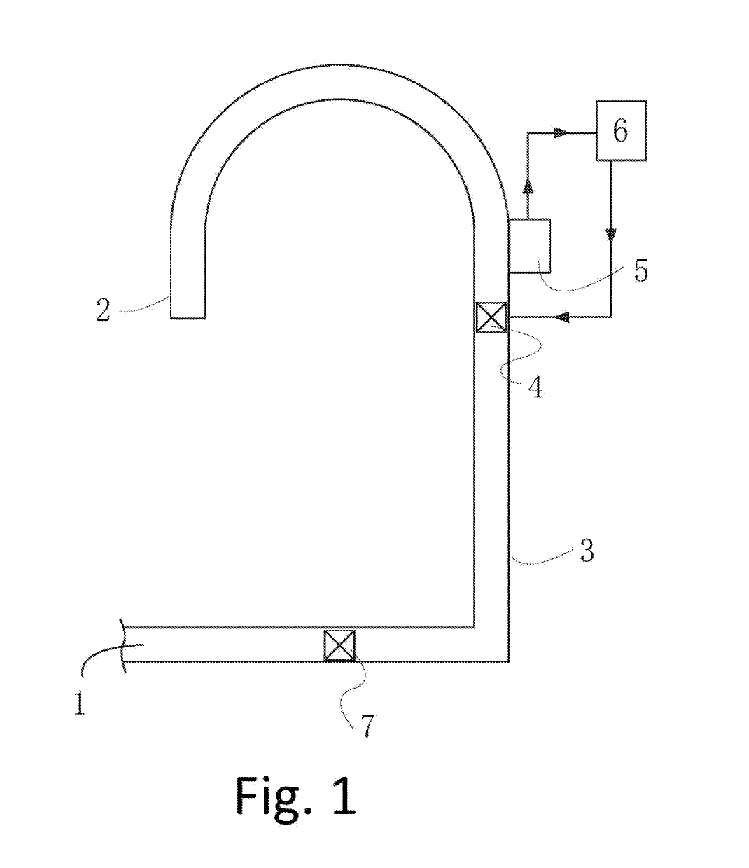

In FIG. 1 a schematic diagram of a structure according to the present invention is shown. The piezoelectric touch-controlled faucet according to the present invention comprises a first end 1 connected to a water supply source, a second end 2 having a water outlet for the faucet, and a passage 3 arranged between the first end 1 and the second end 2 and used to lead the water from the first end 1 to the second end 2. The piezoelectric touch-controlled faucet further comprises an electronic valve 4 arranged on the passage 3, a piezoelectric sensor 5 provided underneath a touch area 21 which is arranged on the external surface of the passage 3, and an electronic control unit 6 connected to the piezoelectric sensor 5 to receive signal from the piezoelectric sensor 5 for controlling the electronic valve 4 on and off, wherein the electronic control unit 6 may include an automatic time delaying unit.

Specifically, the electronic valve 4 may be a solenoid valve.

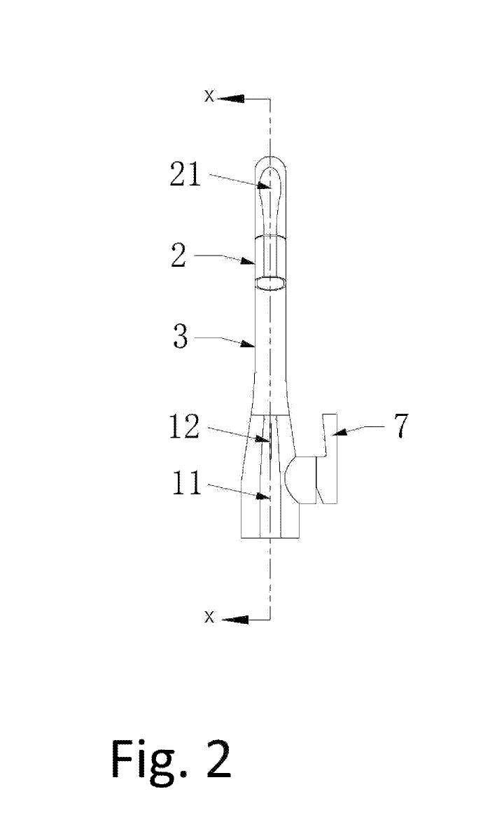

In use, generally the outlet, i.e. the second end 2 in the present invention, is supposed to be arranged nearer to users relative to the water inlet, therefore, for ease of use, preferably, the touch area 21 in the present invention is arranged near the second end 2, as shown in FIG. 2.

In a preferred embodiment, the first end 1 is connected to a hot water supply source and a cold water supply source at the same time.

Further, the piezoelectric touch-controlled faucet according to the present invention further includes a temperature control touch area 11.

Further, the faucet according to the present invention may comprises a LED temperature indicator 12 arranged near the temperature control touch area 11.

With the faucets in the prior art, people are used to operating a manual valve arranged near the first end 1, therefore the piezoelectric touch-controlled faucet according to the present invention may also include a manual valve 7 with a handle arranged in the passage 3 at a position near the first end 1, wherein the handle is used to control the manual valve 7 on and off and to regulate water temperature. Such a manual valve is well known in the prior art, so not elaborated herein. Under normal circumstances, the manual valve is opened, the water flow and the water temperature are controlled by a user with the touch area 21 and the temperature control touch area 11. In case of the touch area 21 and the temperature control touch area 11 being out of work because of faults, the user can operate the manual handle to release water and regulate water temperature.

In cooperation with the manual valve, preferably, the temperature control touch area 11 is also arranged near the first end 1.

In order to adjust the direction of the water flow from the outlet, preferably, the second end 2 is detachably connected to the passage 3, wherein a hosepipe is arranged within the passage 3, and connected with the second end 2. When people need to adjust the direction of the water flow, they just need to rotate or even detach the second end 2. Of course, other implementations are possible, for example, the hosepipe may be flexible, or provided with a counter weight at the other end, the user may pull the second end 2 in a particular direction to adjust the direction of the outgoing water.

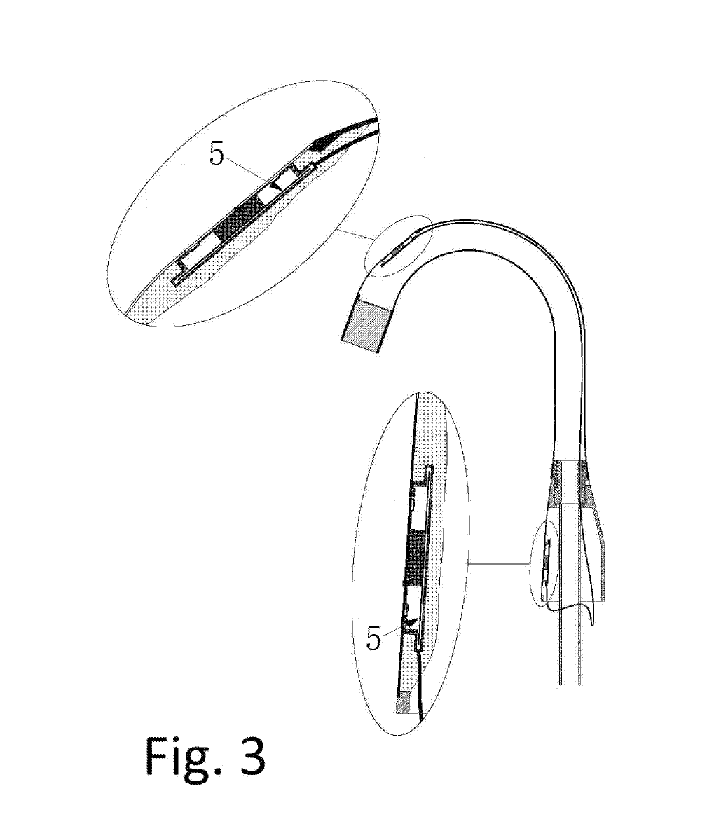

Now please make reference to FIG. 3, in which a side section view of the embodiment in FIG. 2 along the section line X-X is shown. The touch area 21 and the temperature control touch area 11 are both connected to a power supply via wires, and the touch area 21, the temperature control touch area 11 and the wires are isolated from water, for example, the touch area 21 and the temperature control touch area 11 are sealed with silicone sealants.

The embodiments described above are just preferred instead of limit, any other identical or similar technical means which can achieve the technical effects in the present invention should be considered within the protection scope of the present invention.

1. A piezoelectric touch-controlled faucet, comprising:
a first end (1) connected to a water supply source,
a second end (2) comprising a water outlet for the faucet,
a passage (3) arranged between the first end (1) and the second end (2) for directing the water from the first end (1) to the second end (2),
characterized in further comprising:
an electronic valve (4) arranged within the passage (3),
a touch area (21) arranged on the external surface of the passage (3), covering an certain area,
a piezoelectric sensor (5) arranged inside the external wall of the passage (3) underneath the touch area (21),
an electronic control unit (6) connected to the piezoelectric sensor (5) for receiving signal from the piezoelectric sensor (5) to control the electronic valve (4) on and off,
wherein the electronic control unit (6) comprises an automatic time delaying unit.

2. The piezoelectric touch-controlled faucet of claim 1, characterised in that: the electronic valve (4) is a solenoid valve.

3. The piezoelectric touch-controlled faucet of claim 1, characterised in that: the touch area (21) is arranged near the second end (2).

4. The piezoelectric touch-controlled faucet of claim 1, characterised in that: the first end (1) is connected to a hot water supply source and a cold water supply source at the same time.

5. The piezoelectric touch-controlled faucet of claim 1, characterised in that: the piezoelectric touch-controlled faucet further comprises a temperature control touch area (11).

6. The piezoelectric touch-controlled faucet of claim 5, characterised in that: a LED temperature indicator (12) is arranged near the temperature control touch area (11).

7. The piezoelectric touch-controlled faucet of claim 5, characterised in that: the temperature control touch area (11) is arranged near the first end (1).

8. The piezoelectric touch-controlled faucet of claim 1, characterised in that: the second end (2) is detachably connected to the passage (3), a hosepipe is arranged in the passage (3), and the second end (2) is connected with the hosepipe.

9. The piezoelectric touch-controlled faucet of claim 1, characterised in that: the piezoelectric touch-controlled faucet further comprises a manual valve (7) arranged within the passage (3), and a handle for controlling the manual valve (7) on and off and for regulating water temperature.

10. The piezoelectric touch-controlled faucet of claim 1, characterized in that: the piezoelectric sensor (5) is provided with a water-proof layer.

11. The piezoelectric touch-controlled faucet of claim 6, characterised in that: the temperature control touch area (11) is arranged near the first end (1).
